(19) United States
(12) Patent Application Publication
(10) Pub. No.: US 2004/0114800 A1
(43) Pub. Date: Jun. 17, 2004

(54) System and method for image segmentation

(75) Inventors: Artem L. Ponomarev, Pearland, TX (US); Ronald L. Davis, Houston, TX (US)

Correspondence Address: FULBRIGHT & JAWORSKI, LLP, 1301 MCKINNEY, SUITE 5100, HOUSTON, TX, 77010-3095, US

(73) Assignee: Baylor College of Medicine

(21) Appl. No.: 10/663,049

(22) Filed: Sep. 12, 2003

Related U.S. Application Data
(60) Provisional application No. 60/410,170, filed on Sep. 12, 2002.

(51) Int. Cl. G06K 9/34; G06K 9/00

(52) U.S. Cl. 382/173; 382/128

(57) ABSTRACT

The present invention relates a system and method of image analysis, and more particularly to a computer-implemented system and method for object identification through segmentation. The system and method allows for segmenting homogenous or inhomogeneous objects of rather uniform dimensions and geometry in 2-dimensional or 3-dimensional images. The system and method is based upon image data point similarity sorting and contour identification.

### SPECIFICATION

This U.S. Patent Application claims priority to presently co-pending provisional U.S. Application No. 60/410,170, filed on Sep. 12, 2002, which is incorporated herein in its entirety.

### STATEMENT REGARDING FEDERALLY SPONSORED RESEARCH OR DEVELOPMENT

This invention was made with government support under NIMH Grant No. GM69420 awarded by the National Institutes of Health. The United States Government may have certain rights in this invention.

### FIELD OF THE INVENTION

The present invention relates to image analysis, and more particularly to a computer-implemented method for object identification through segmentation of a 2- or 3-dimensional image.

### BACKGROUND OF THE INVENTION

Digital imaging is used in many different areas of science, government, and in the commercial sector. The rapid progress in microscopy and digital imaging has produced many new challenges in image analysis. Many of the images now obtained from confocal or two-photon microscopy, satellite photos or telephotograph, for instance, are rich with information, and may contain hundreds or thousands of objects of perhaps variable size and location.

The amount of information contained within these images frequently prohibits a clear and complete analysis by simple inspection. Computational tools are required to sort through the images in order to obtain a better comprehension of the images, or to extract the salient features or those that are important to the individual investigator. Such complex dimensional images need to be processed through image analysis programs to identify various objects, borders and other features within the image.

The identification of objects through image analysis is generally known as segmentation. Segmentation is broadly defined as the computational steps required for identifying discrete objects or image areas that are relatively homogenous. Various segmentation methods have been developed. In the art there is no general approach as to how segmentation of images should be performed.

For example, several segmentation approaches are based on thresholding. In the simplest of 2-dimensional images, in a first approach, objects of interest are represented by pixels of high intensity relative to the background of the image so that islands of contiguous high pixel intensity can be defined by simply establishing a threshold. This can be effective with objects that are well separated and when they are represented by pixels with high and uniform pixel intensity relative to background. All areas of a 2-dimensional image having a specific intensity level or higher are defined as representing an object or a portion of an object. Two or more adjacent areas of the 2-dimensional image having image pixels with intensities above a threshold would be defined as representing portions of the same object. This method works well for simple 2-dimensional images containing objects with homogeneous intensity values. However, such a method does have certain limitations. For example, objects with certain features such as holes, valleys or other irregularities cannot be properly identified as a unit. This is so because such features would fall below the intensity threshold.

A second segmentation approach based on thresholding is to make the threshold variable, either locally or through an iterative scheme and base the image analysis on a mathematical construct that works with light intensity distributions and/or geometric properties of the objects to be segmented.

A third segmentation approach based on thresholding centers, on using model-based schemes, such as neural networks or oscillator networks (as in the LEGION method, Chen and Wang, 2002) that can be made to produce the desired result.

One segmentation method in the Metamorph™ package is easily applicable to a 2-dimensional representation of a flow cytometry device, in which cells can be counted after simple thresholding. It is limited because red cells may appear quite different at different angles of orientation with respect to the viewer. A 3-dimensional segmentation task is not easy to implement in this package.

The Amira™ package does not allow fast segmentation of large number of small objects because it is not fully automatic.

The LEGION method (Shareef et al., 1997; Chen and Wang, 2002) seems to involve a model that mimics the workings of a human eye to recognize images.

Some of the above methods and computer programs are not suited for 3-dimensional images or not designed for grey-scale images. Segmentation of objects in a complex 3-dimensional image raises certain challenges. 3-dimensional images are essentially stacks of many 2-dimensional images layered on top of one another so as to create a 3-dimensional volume. With a 3-dimensional image, objects need to be identified, not only along x- and y- axes, but also along the z-axis.

The most general approach to 3-dimensional object segmentation is based on the likelihood estimation of a given voxel belonging to a given population in the image (Oh and Lindquist, 1999; Mardia and Hainsworth, 1988). A population can be the background, a nucleus, or any other object.

A particular realization of the general approach is the Kriging method, which is based on the assumption that the statistical properties of intensity fluctuations within populations are known (Oh and Lindquist, 1999). The mean and the covariance of the intensity need to be known for arbitrary sets of voxels to determine their “likeness” of membership in one particular object. The probability of a voxel belonging to the same object together with its neighbor is determined by a solution of a constrained minimization problem, in which pairwise covariances of neighboring voxel intensities are assumed to be known.

The present invention is the first to utilize an image segmenting method based on simple geometric ideas. Thus, it is envisioned that the segmentation method of the present invention can be used in may areas of biology where the count, location and identification of biological objects are needed. It is also envisioned that the segmentation method may be extended beyond biological applications to fields such as astronomy, where stars, planets, and other astronomical bodies need to be identified, tracked, and counted in 2- or 3-dimensional photorepresentations. It is also envisioned that the segmentation method may be extended to satellite photography, either civilian or military, where objects need to be quickly identified based on geometrical properties. Indeed, the image segmentation method, in principle, is applicable to any endeavor in which objects within 2- or 3-dimensional space need to be identified from any type of digital image.

### SUMMARY OF THE INVENTION

The present invention relates to image analysis, and more particularly to a computer-implemented method for object identification through segmentation. The computer-implemented method allows for segmenting homogenous or inhomogeneous objects of rather uniform dimensions and geometry in 2-dimensional or 3-dimensional images.

The inventive system and method is based upon image data point similarity sorting, contour identification, and geometrical properties. The present invention combines image data points above a local threshold into a segmented object, which is a similarity principle; and defines a contour with image datapoints of similar intensity, which is the surface of the segmented object, and then tests whether that digital representation of the object fulfills geometrical rules of being a square, a sphere, a cube, a pyramid, or any other shape that can be expressed mathematically.

The present invention utilizes an adjustable threshold. The method currently identifies with a high precision the location of blurry and generally spherically shaped objects. The method circumvents the inhomogeneities of objects by adjusting the local threshold for each point in the image to fit the locally segmented region into contextual and geometrically defined criteria that describe the real object.

The novel segmentation system and method has applicability in analysis of 2- and 3-dimensional images in a variety of areas. The method may be utilized for different types of tissue or analogous problems of image analysis in biology. Other scientific areas of applicability include astronomy, meteorology and geology. Indeed the present invention has applicability where a need exists to identify in a digital image, one or more objects of similar geometry and size, or of varying geometry and size.

The present invention will be of great value for the study of many questions in biomedicine and for rapid and accurate disease diagnosis from pathological specimens. For example, it could be utilized for the rapid and automated quantitation of image features that are of interest to the pathologist such as counts of viral particles and abnormal cells in cancer screening and disease diagnosis.

In addition to being used to diagnose disease from pathological specimens, the present invention can also be utilized for general biological questions for example, what are the levels of expression of a gene and/or protein of interest, identifying and/or quantifying cell structures i.e., synapses/neuron, mitochondria/cell, senile plaques, inclusions, etc. Thus, it is envisioned that the present invention may also be used as a general laboratory technique.

In one embodiment of the invention there is a computer-implemented method for segmenting objects in an image dataset. The method includes the steps of reading an image dataset containing an electronic representation of an image, where the image has a plurality of data points; determining one or more initial defining sets by finding interconnected sets of the data points; and determining one or more valid defining sets by applying one or more restricting conditions to the initial defining sets; and identifying one or more segmented objects. This embodiment of the invention has numerous aspects and features as listed below.

One aspect of the aforementioned method is that the data points have an associated intensity value. Also the data points may have an associated Red, Green, Blue wavelength values. Other value characters such as frequency or specific combinations of value characters may be ascribed to the data points. The data points may be pixels, voxels, or other image data point.

In one aspect of the invention, finding interconnected sets of the data points includes finding a path of successive neighboring data points where a subsequent neighboring data point has an intensity value equal to or greater than an intensity value of a previous data point. The path is limited to a predetermined length of data points. Each step of the path may be linear and also may be diagonal.

In one aspect of the invention, the electronic representation of an image is a 2-dimensional or 3-dimensional representation. Also the electronic representation of the image may be a grey-scale or color representation.

In another aspect of the invention, the image dataset may be in various formats such as JPEG, BMP, TIFF, GIF or other image data formats. Additionally, the image dataset may be a database, a computer file, or an array of data in computer memory.

In one aspect of the invention, applying one or more restricting conditions includes applying criteria for an initial defining set, such that the initial defining set will be excluded from being a valid defining set.

In yet another aspect of the invention, applying one or more restricting conditions includes applying criteria for an initial defining set, such that the initial defining set will be included as being a valid defining set.

In one aspect of the invention, applying one or more restricting conditions includes excluding the initial defining set where the initial defining set has a volume greater than or equal to a predetermined maximum volume.

In one aspect of the invention, applying one or more restricting conditions includes excluding the initial defining set where the initial defining set has a volume lesser than or equal to a predetermined minimum volume.

In one aspect of the invention, applying one or more restricting conditions includes excluding an initial defining set where the initial defining set has an extent in an x- and y-direction greater than a predetermined maximum extent.

In one aspect of the invention, applying one or more restricting conditions includes excluding an initial defining set where the initial defining set has an extent in a z-direction greater than a predetermined maximum extent.

In one aspect of the invention, applying one or more restricting conditions includes excluding an initial defining set where the initial defining set has a sphericity greater than or equal to a predetermined maximum sphericity.

In one aspect of the invention, applying one or more restricting conditions includes excluding the initial defining set where the initial defining set has a sphericity lesser than or equal to a predetermined minimum sphericity.

In one aspect of the invention, the aforementioned method includes counting the segmented objects.

In one aspect of the invention, the aforementioned method includes displaying the segmented objects in a graphical user interface.

In one aspect of the invention, the aforementioned method includes determining a centroid for the segmented objects.

In one aspect of the invention, the aforementioned method includes displaying the centroids for the segmented objects.

In one aspect of the invention, the aforementioned method includes overlaying a grid with the centroids to aid in visual reference of the centroids.

In one aspect of the invention, the aforementioned method includes determining an intensity threshold for the segmented objects. For example, the intensity threshold for a particular segmented object is the intensity of the dimmest voxel, where the image is a 3-dimensional image. Additionally, for example, the intensity threshold for a particular segmented object is the intensity of the dimmest pixel, where the image is a 2-dimensional image.

In one aspect of the invention, the aforementioned method includes smoothing the image of image dataset to remove image artifacts from the image before the step of determining one or more initial defining sets.

In further aspects, the present invention includes a method of determining transcriptional activity of a gene of interest comprising the steps of: obtaining a biological sample; imaging the sample to obtain an image dataset; and using the aforementioned method to identify one or more segmented objects such that the identified segmented objects correlate to the transcriptional activity of the gene of interest.

Another aspect of the present invention includes a method of determining and/or quantifying the expression level of a gene of interest comprising the steps of: obtaining a biological sample; contacting said sample with a substance that can be used to determine the expression level of a gene of interest; imaging the sample to obtain an image dataset; and using the aforementioned method to identify one or more segmented objects such that the identified segmented objects correlate with the gene expression level.

Still further, another aspect includes a method of determining and/or quantifying the expression level of a protein of interest comprising the steps of: obtaining a biological sample; contacting said sample with a substance that can be used to determine the expression level of a protein of interest; imaging the sample to obtain an image dataset; and using the aforementioned method to identify one or more segmented objects such that the identified segmented objects correlate with the protein expression level.

Another aspect includes a method of diagnosing a hyperproliferative disease comprising the steps of: obtaining a biological sample from a subject; imaging the sample to obtain an image dataset; and using the aforementioned method to identify one or more segmented objects, wherein the identified segmented objects correlate to the hyperproliferative disease. The hyperproliferative disease may be further defined as cancer, which may comprise a neoplasm. Specifically, the neoplasm is selected from the group consisting of melanoma, non-small cell lung, small-cell lung, lung hepatocarcinoma, retinoblastoma, astrocytoma, gliobastoma, leukemia, neuroblastoma, squamous cell, head, neck, gum, tongue, breast, pancreatic, prostate, renal, bone, testicular, ovarian, mesothelioma, sarcoma, cervical, gastrointestinal, lymphoma, brain, colon, and bladder.

Still further, another aspect includes a method of screening a subject at risk for developing a hyperproliferative disease comprising the steps of: obtaining a biological sample from a subject; imaging the sample to obtain an image dataset; and using the aforementioned method to identify one or more segmented objects, wherein the identified segmented objects correlate to the hyperproliferative disease.

Another aspect includes a method of staging or monitoring a hyperproliferative disease in a subject comprising the steps of: obtaining a biological sample from a subject; imaging the sample to obtain an image dataset; and using the aforementioned method identify one or more segmented objects, wherein the identified segmented objects correlate to the hyperproliferative disease.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings.

The patent or application file contains at least one drawing executed in color. Copies of this patent or patent application publication with color drawing(s) will be provided by the Office upon request and payment of the necessary fee.

FIGS. 1(A-F) illustrate several Z-sections of a typical Z-stack of the Drosophila brain nuclei. FIG. 1 A shows a typical image of a Drosophila brain at 12 μm deep; at 17 μm (FIG. 1B) and at 23 μm (FIG. 1C). FIGS. 1D-1F show the result of smoothing and segmentation for the slices of FIGS. 1A-1C;

FIG. 2 illustrates segmentation of two nearby brain nuclei by allowing for sufficiently high and different threshold values;

FIG. 3A and FIG. 3B illustrate segmentation of DNA-protein in HeLa cells. FIG. 3A illustrates the nucleus (blue) and protein products (red). FIG. 3B shows that the protein products can be segmented separately to identify the intensity of object;

FIG. 4A and FIG. 4B illustrate segmentation of prostate cancer biopsy samples. FIG. 4A shows cancer cells labeled with brown chromogen. FIG. 4B shows the segmentation of FIG. 4A which identified malignant cells;

FIG. 5A and FIG. 5B illustrate segmentation of bladder cancer samples. FIG. 5A shows bladder cancer cells and the telomeres are labeled in green. FIG. 5B shows the segmentation of FIG. 5A which identified malignant cells;

FIG. 6A-FIG. 6C illustrate segmentation of non-Hodgkin's lymphoma. FIG. 6A shows cells in which DAPI was used to stain the nuclei. FISH (fluorescence in situ hybridization) was used to label cyclin D1 and IgH. FIG. 6B shows the results of the first round of 2D-segmentation. FIG. 6C shows the segmentation of FIG. 6B which identified malignant cells.

### DETAILED DESCRIPTION OF INVENTION

I. Definitions

As used herein, the use of the word “a” or “an” when used in conjunction with the term “comprising” in the sentences and/or the specification may mean “one,” but it is also consistent with the meaning of “one or more,” “at least one,” and “one or more than one.”

A. Segmentation Terms

The term “pixel” as used herein is used to characterize a data point in an image on an x-,y-axis. A 2-dimensional image ordinarily contains pixel elements that represent a picture. The particular intensity (I) of a pixel is associated with an x-, y-coordinate value at I_{xy}.

The term “voxel” as used herein is used to characterize an image volume element. The voxel is a three-dimensional pixel that has four associated values: x,y, and z coordinate values, and an intensity value (I) indicating the intensity of the voxel. A specific voxel is found at the location v_{xyz}. The particular intensity of a voxel can be found at I_{xyz}

The term “image dataset” as used herein is a file, database or computer memory containing an electronic representation of an image. The electronic representation may be a 2-dimensional image having data points based on pixels (i.e., having an x-,y-axis), or a 3-dimensional image have data points based on voxels (i.e., having an x-,y-,z-axis).

The term “interconnected set” as used herein is a set of pixels or voxels of a certain pre-determined length, L, such that there exists a path defined for the pixels or voxels within the set that connects one voxel to another within the set.

The term “initial defining set” as used herein are those data points (e.g., voxels or pixels) within an interconnected set that have an equal or higher intensity, than other data points (e.g., voxels or pixels) within the interconnected set.

The term “restricting conditions” as used herein are certain value inclusion or exclusion ranges for data points (e.g., voxels pixels). The restricting conditions are user-definable and can be optimized by trial and error.

The term “valid defining set” as used herein is an initial defining set that satisfies restricting conditions. A valid voxel v_{xyz} is a voxel whose initial defining set is a valid defining set. A valid pixel v_{xy} is a pixel whose initial defining set is a valid defining set.

The term “segmented object” as used herein is where a group of valid voxels or pixels forms an interconnected set, in particular, the unity of their initial defining sets (which are also valid defining sets). A segmented object is equivalent to its dimmest valid voxel's or pixel's valid defining set.

The term “centroid” as used herein is a point in space given by a sum of (x,y,z) locations of the voxels belonging to a segmented object divided by V (the volume of the segmented object). A centroid appears to be roughly at the center of a visible object. This is a standard technique for assigning a single point to an object. The matrix of centroids is the resulting three-dimensional map of the objects in the image that can be studied further.

B. Biological Terms

The term “cancer” as used herein is defined as a hyperproliferation of cells whose unique trait—loss of normal controls—results in unregulated growth, lack of differentiation, local tissue invasion, and metastasis. Examples include, but are not limited to, breast cancer, prostate cancer, ovarian cancer, cervical cancer, skin cancer, pancreatic cancer, colorectal cancer, renal cancer and lung cancer.

The term “hyperproliferative disease” is defined as a disease that results from a hyperproliferation of cells. Hyperproliferative disease is further defined as cancer. The hyperproliferation of cells results in unregulated growth, lack of differentiation, local tissue invasion, and metastasis. Exemplary hyperproliferative diseases include, but are not limited to cancer or autoimmune diseases. Other hyperproliferative diseases include, but are not limited to neurofibromatosis, rheumatoid arthritis, Waginer's granulomatosis, Kawasaki's disease, lupus erathematosis, midline granuloma, inflammatory bowel disease, osteoarthritis, leiomyomas, adenomas, lipomas, hemangiomas, fibromas, vascular occlusion, restenosis, atherosclerosis, pre-neoplastic lesions, carcinoma in situ, oral hairy leukoplakia, or psoriasis, and pre-leukemias, anemia with excess blasts, and myelodysplastic syndrome.

The term “neoplasm” as used herein is referred to as a “tumor”, and is intended to encompass hematopoietic neoplasms as well as solid neoplasms. Examples of neoplasms include, but are not limited to melanoma, non-small cell lung, small-cell lung, lung, hepatocarcinoma, retinoblastoma, astrocytoma, gliobastoma, gum, tongue, leukemia, neuroblastoma, head, neck, breast, pancreatic, prostate, renal, bone, testicular, ovarian, mesothelioma, sarcoma, cervical, gastrointestinal, lymphoma, brain, colon, bladder, myeloma, or other malignant or benign neoplasms.

The term “gene” as used herein is defined as a functional protein, polypeptide, or peptide-encoding unit. As will be understood by those in the art, this functional term includes genomic sequences, cDNA sequences, and smaller engineered gene segments that express, or is adapted to express, proteins, polypeptides, domains, peptides, fusion proteins, and mutants.

The term “polynucleotide” as used herein is defined as a chain of nucleotides. Furthermore, nucleic acids are polymers of nucleotides. Thus, nucleic acids and polynucleotides as used herein are interchangeable. One skilled in the art has the general knowledge that nucleic acids are polynucleotides, which can be hydrolyzed into the monomeric “nucleotides.” The monomeric nucleotides can be hydrolyzed into nucleosides. As used herein polynucleotides include, but are not limited to, all nucleic acid sequences which are obtained by any means available in the art, including, without limitation, recombinant means, i.e., the cloning of nucleic acid sequences from a recombinant library or a cell genome, using ordinary cloning technology and PCR™, and the like, and by synthetic means. Furthermore, one skilled in the art is cognizant that polynucleotides include mutations of the polynucleotides, include but are not limited to, mutation of the nucleotides, or nucleosides by methods well known in the art.

The term “polypeptide” as used herein is defined as a chain of amino acid residues, usually having a defined sequence. As used herein the term polypeptide is interchangeable with the terms “peptides” and “proteins”.

The term “promoter” as used herein is defined as a DNA sequence recognized by the synthetic machinery of the cell, or introduced synthetic machinery, required to initiate the specific transcription of a gene.

The term “DNA” as used herein is defined as deoxyribonucleic acid.

The term “RNA” as used herein is defined as ribonucleic acid. The term “recombinant DNA” as used herein is defined as DNA produced by joining pieces of DNA from different sources.

II. Segmentation System and Method

The inventive system and method partitions the whole space of an image in an image dataset into the background and defined object subsets according to a defined set of rules, and then tests the partition to determine if it is acceptable and if the created spatial pattern of object matches the visible one with spatial precision. An operator may be the final evaluator of the efficiency of the method. The operator may adjust the parameters that control the partition to maximize the probability of proper segmentation.

The inventive system and method is based on image data point similarity sorting and contour identification. The present invention combines data points (e.g., pixels, voxels, etc.) equal to or above a local intensity threshold into a segmented object, and defines a contour with data points of equal intensity. The method includes the steps of:

1. reading an image dataset containing an electronic representation of an image, where the image has a plurality of data points;

2. determining one or more initial defining sets by finding interconnected sets of the data points;

3. determining one or more valid defining sets by applying one or more restricting conditions to the initial defining sets; and

4. identifying one or more segmented objects.

The image dataset contains an electronic representation of an image. The image dataset may be a database, a computer file, or an array of data in computer memory. The image may be a 2-dimensional or 3-dimensional image. Additionally, the image may be a time-sliced image representing the state of the image at a particular time sequence. The images have a number of data points representing the image. The data points may be pixels, voxels, or other types of image data points. The data points have an associated intensity value. Also the data points may have an associated grey-scale value or color-scale value such as Red, Green, Blue. The image dataset may be in various formats such as JPEG, BMP, TIFF, GIF or other image data formats. To remove image artifacts from an image before the step of determining one or more initial defining sets, the image of image dataset may be smoothed.

The image dataset is read to determine one or more initial defining sets. An initial defining set for a 3-dimensional image are those interconnected sets that contains v_{xyz} with all other voxels v_{uvw} within an interconnected set having I_{uvw}≧I_{xyz}. An initial defining set for a 2-dimensional image are those interconnected sets that contains P_{xy} with all other pixels Pᵤᵥ within an interconnected set having Iᵤᵥ≧I_{xy}, There is one and only one initial defining set for each data point (e.g., voxel or pixel) in an image. This construct is based on the idea that if a data point were to belong to an object, all of its interconnect neighbors with the same or higher intensity also belong to the object. This is much different than some more general methods where a data point has only a certain probability to belong to an object based on some measure of data point similarity defined the vicinity of this data point. As part of a preprocessing step the image dataset may be parsed to either remove or identify those datapoints that fall below a particular intensity value.

The intensity or I value may be given as a grey scale value or obtained from a false color look-up table with the proper weight of RGB channels. A common eight-bit grey scale value has a value between 0 (black) and 255 (white). The grey scale values ranging between 0-255 indicates the intensity. For example, if a voxel has an I value of zero or near zero, this would indicate that voxel of the image was dark. If a voxel has an I value of 255 or near 255, this would indicate that voxel of the image was very light. Thus, the higher the number for the voxels of a certain volume of an image is, the brighter (or whiter) that volume would be.

These initial defining sets are based on the evaluation of an interconnected set of data points, such as pixels in a 2-dimensional image and voxels in a 3-dimensional image. An interconnected set can be visualized as an island in space and has an arbitrary shape, and may even have holes inside of it, but the interconnected set is one object in a topological sense. In a 2-dimensional image initial defining sets are based on interconnected sets of pixels. The interconnected sets are a series of pixels in the ±x, ±y directions for a 2-dimensional image. For a 3-dimensional image the initial defining sets are based on interconnected sets of voxels in the ±x, ±y, ±z directions.

Finding interconnected sets of the data points includes finding a path of successive neighboring data points where a subsequent neighboring data point has an intensity value equal to or greater than an intensity value of a previous data point. To determine an interconnected set of data points, the method evaluates a first data point in space (a first location) and compares that data point in space with the neighboring data point (a second location) in space. Next, the second data point is compared with a third image data point, as so on. The number of data points compared is based on a path having a predetermined value for the length. For example, the length of the path may be set at 5. The number of data points for comparison in the path would then be limited to 5. The path is limited to a predetermined length of data points. The path may be linear and also may be diagonal. For a 3-dimensional image, the path is a line in space for data points drawn continuously from one voxel to another in ±x, ±y, ±z directions. For a 2-dimensional image, the path is a line in space for data points drawn continuously from one pixel to another pixel in ±x, ±y directions. Using only a linear path for evaluating neighboring data points from a data point of origin in a 2-dimensional image, four directions evaluated, in a 3-dimensional image six directions are evaluated. If a diagonal path is also evaluated, then 8 directions are evaluated for a 2 dimensional image, and 26 directions for a 3-dimensional image. Preferably, all of the data points are evaluated to find interconnected sets. However, certain data points may be excluded from determining interconnected sets. For example, those datapoints falling below a certain intensity threshold.

Restricting conditions are applied to initial defining sets to determine valid defining sets. Restricting conditions are user-defined and can be optimized by trial and error. If one is interested in the number of objects only, but not in their locations, the precision is even higher, since different errors compensate for each other: split objects and improperly identified objects add to the count, but missed and fused objects reduce the count. The accuracy has reached 98.1% so far for automatic counting. This is the result for a cleanly imaged stack. The method is not designed to correct imaging problems such as bleaching or optical aberrations.

Applying one or more restricting conditions includes applying a criteria for an initial defining set, such that the initial defining set will either be excluded from being a valid defining set, or will be included as being a valid defining set.

For example, for purposes of illustration, but not limitation, some restrictive conditions include:

1. Vₘₐₓ is the maximum volume of an initial defining set.

2. Vₘᵢₙ is the minimum volume of an initial defining set.

3. L_{xy}^{max} is the maximum extent of an initial defining set in the x and y directions.

4. L_{z}^{max} is the maximum extent of an initial defining set in the z direction.

5. Gₘₐₓ is the maximum sphericity.

6. Gₘᵢₙ is the maximum sphericity.

7. PSF (point spread function) is determined empirically or theoretically and is used in calculating G for objects elongated in z-direction (depth) due to PSF (G is compared with Gmax or Gmin).

8. Mean-square intensity fluctuation within an objects can be used to separate objects from the more fluctuating background.

9. Some objects satisfying the restringing conditions above but belonging to “tails” of the population distribution in a given parameter (such as extent, etc.) may be thrown out at a later stage, as objects not likely to belong to the sought population.

For example, for purposes of illustration, but not limitation, some applications of applying one or more restricting conditions include:

1. excluding an initial defining set where the initial defining set has a volume greater than or equal to a predetermined maximum volume;

2. excluding an initial defining set where the initial defining set has a volume lesser than or equal to a predetermined minimum volume;

3. excluding an initial defining set where the initial defining set has an extent in an x- and y-direction greater than a predetermined maximum extent;

4. excluding an initial defining set where the initial defining set has an extent in a z-direction greater than a predetermined maximum extent;

5. excluding an initial defining set where the initial defining set has a sphericity greater than or equal to a predetermined maximum sphericity; and

6. excluding an initial defining set where the initial defining set has a sphericity lesser than or equal to a predetermined minimum sphericity.

An example of applying a restrictive condition is applying the maximum sphericity. For example maximum sphericity may be defined as

Gₘₐₓ32 R_{g}²/N^{2/3}, (1)

where R_{g} is the gyroradius of an object, a standard measure of sphericity in various areas of science. It is the sum of mean-square distances of voxels from the object center of mass:

$${R}_{g}^{2} = \frac{1}{N} {\sum }_{i = 0}^{N} {( {r}_{i} - {R}_{C M} )}^{2} \qquad ( 2 )$$

where rᵢ is the location of a voxel, R_{CM} is the center of mass of an object, and N is the number of voxels in the object, or the volume.

The gyroradius assumes a minimal value for a perfect sphere with no holes. It depends, however, on the volume of a sphere. Gₘₐₓ may be normalized by the volume so that it is volume-independent (as in Eq. (1)) and depends only on the shape of the object. In the continuous limit a spherical object minimizes this parameter (Gₘₐₓ)ₘᵢₙ→0.23. In the case of some objects that are not perfectly round, the restricting value of Gₘₐₓ=0.3 was chosen for optimal segmentation. The check for sphericity is performed by a subalgorithm, termed the splitting algorithm, that checks suspected fused objects if such are left after segmentation based on the other restrictive conditions. If such is the case the local threshold is further raised to split an object and to make the resulting parts satisfy all the restrictive conditions.

The segmented objects then are identified as a group of valid data points (e.g., voxels or pixels) forms an interconnected set, in particular, the unity of their initial defining sets (which are also valid defining sets). A segmented object is equivalent to its dimmest valid datapoints valid defining set.

While the segmented objects are identified or after they are identified the objects may be visually displayed in a graphical user interface. Additionally, various functions or processes may be performed upon the identified segmented objects. For purposes of illustration, but not limitation, some of these functions and processes include:

1. counting the segmented objects;

2. determining a centroid for the segmented objects;

3. displaying the centroids for the segmented objects;

4. overlaying a grid with the centroids to aid in visual reference of the centroids;

5. determining an intensity threshold for the segmented objects. For example, the intensity threshold for a particular segmented object is the intensity of the dimmest voxel, where the image is a 3-dimensional image. Additionally, for example, the intensity threshold for a particular segmented object is the intensity of the dimmest pixel, where the image is a 2-dimensional image; and the intensity threshold for a particular segmented object is the intensity of the dimmest pixel, where the image is a 3-dimensional image; and

6. counting of possible errors of segmentation by putting marks in the input file (and displaying the marks), and recording errors into a database, which may result from

6.1. missed objects (real objects not counted by segmentation);

6.2 split object (one object counted as two);

6.3 fused object (assignment of one centroid to two objects);

6.4 assignment of an object belonging to other population of objects to the sought population;

7. displaying centroids as an interactive 3-dimensional map of points; and

8. excluding or including margins in the images for segmentation. If including margins, only areas with the offset of two maximum extents is segmented. If excluding margins, the whole image is segmented, but segmentation at the borders of an image might lead to additional errors, such as enumerated in 6.

9. merging centroids of the overlapping images into one map using the interface and the common area between two images with the purpose of proper alignment of the two corresponding maps of centroids;

10. displaying centroids from two overlapping images simultaneously in one window;

11. applying translational, rotational and scaling transformations to the map of centroids;

12. counting resulting volumes, surface areas and total intensities of identified segmented objects and determining corresponding statistics of these parameters for a given population;

13. displaying identified segmented objects in random color to be able to tell that two objects in one of their 2-d dimensional projections are two separated entities, and do not join together in any other projection, if in such display they appear differently colored.

It may appear that the concept of the threshold does not appear anywhere in the method. In reality the intensity of any given data point is chosen as the threshold for the initial defining set that corresponds to that data point. Since some data points are discarded as not belonging to any object, and the resulting valid defining sets correspond to the initial defining sets of their dimmest data points, the intensities of those dimmest data points of the defined object are the final thresholds, which may vary from object to object.

The results of segmentation of any typical image dataset can be displayed in a custom-designed software program having a graphical user interface. For example, the computer-implemented method may be performed utilizing an object-oriented Multiple Document Interface program written in Visual C++ with OpenGL wrapper classes and the Libtiff library. The computer software program may be configured to allow input of parameters for the method. Reading of the dataset may be done and a single or multiple passes. Additionally, working files may be generated to keep track of the initial defining set, the valid defining sets, and/or the segmented objects. The method may be implemented in a stand-alone software application, or may be implemented in a client/server or muli-tier architecture. For example, in a networked environment, such as the Internet, or an intranet, a client application may be utilized to submit an image dataset to a central server for processing to determine segmented objects in the image. Alternatively, a client application may retrieve executable code from a server and execute the computer-implemented method such that the computer executing the method performs the entire method. Additionally, different steps of the method may be performed on one or more computers and/or servers.

Where the image is a multicolor image, the image may be separated into separate files based on a color component. For example, a color file may be separated into three files based on the Red, Green and Blue channel of the file. For each separate file, the aforementioned method may be applied and an output file with the identified segmented objects can be generated. Individually, the files would show different segmented objects based on the particular color channel. The files can be combined to show overlay of segmented objects and color combinations for the datapoints.

III. Uses of the Segmentation Method

The present invention provides a novel method for detecting a disease or measuring the predisposition of a subject for developing a disease in the future by obtaining a biological sample from a subject; imaging the sample to obtain an image dataset using standard imaging techniques; and using the segmentation method of the present invention to identify segmented objects. Segmentation can provide a rapid and automated quantitation of image features, for example, but not limited to counts of viral particles, bacterial particles, fungal particles, any other microbial particles, counts of normal or abnormal cells, determination of gene expression in cells. More specifically, it is envisioned that the segmentation method of the present invention can be used as a cancer-screening and disease-diagnostic tool.

In addition to being used to diagnose disease from pathological specimens, the present invention can also be utilized for general biological questions for example, what are the levels of expression of a gene and/or protein of interest, identifying and/or quantifying cell structures i.e., synapse/neuron, mitochondria/cell, senile plaques, other inclusions, etc. Thus, it is envisioned that the present invention may also be used as a general laboratory technique.

A. Biological Sample Collection and Preparation

In the present invention, the subject will typically be a human but also is any organism, including, but not limited to, a dog, cat, rabbit, cow, bird, ratite, horse, pig, monkey, etc. The sample may be obtained from a tissue biopsy, blood cells, plasma, bone marrow, isolated cells from tissues, skin, hair, etc. Still further, the sample may be obtained postmortem.

Any tissue sample from a subject may be used. Examples of tissue samples that may be used include, but are not limited to, breast, prostate, ovary, colon, lung, brain endometrium, skeletal muscle, bone, liver, spleen, heart, stomach, salivary gland, pancreas, etc. The tissue sample can be obtained by a variety of procedures including, but not limited to surgical excision, aspiration or biopsy. The tissue may be fresh or frozen. In one embodiment, the tissue sample is fixed and embedded in paraffin or the like.

According to one aspect of present invention, the biological or tissue sample may be preferably drawn from the tissue, which is susceptible to the type of disease to which the detection test is directed. For example, the tissue may be obtained by surgery, biopsy, swab, stool, or other collection method. In addition, it is possible to use a blood sample and screen either the mononuclear cells present in the blood or first enrich the small amount of circulating cells from the tissue of interest using methods known in the art.

According to one embodiment of the present invention, when examining a biological sample to detect prostate cancer, it may be preferred to obtain a tissue sample from the prostate. Such a tissue sample may be obtained by any of the above described methods, but the use of biopsy may be preferred. In the case of bladder cancer, the sample may be obtained via aspiration or urine sample. In the case of stomach, colon and esophageal cancers, the tissue sample may be obtained by endoscopic biopsy or aspiration, or stool sample or saliva sample. In the case of leukemia, the tissue sample is preferably a blood sample. In the case of cervical cancers, the tissue sample may be obtained from vaginal cells or as a cervical biopsy.

In another preferred embodiment of the present invention, the biological sample is a blood sample. The blood sample may be obtained in any conventional way, such as finger prick or phlebotomy. Suitably, the blood sample is approximately 0.1 to 20 ml, preferably approximately 1 to 15 ml with the preferred volume of blood being approximately 10 ml.

The tissue sample may be fixed (i.e., preserved) by conventional methodology [See e.g., “Manual of Histological Staining Method of the Armed Forces Institute of Pathology,” 3^{rd} edition (1960) Lee G. Luna, HT (ASCP) Editor, The Blakston Division McGraw-Hill Book Company, New York; The Armed Forces Institute of Pathology Advanced Laboratory Methods in Histology and Pathology (1994) Ulreka V. Mikel, Editor, Armed Forces Institute of Pathology, American Registry of Pathology, Washington, D.C.]. One of skill in the art will appreciate that the choice of a fixative is determined by the purpose for which the tissue is to be histologically stained or otherwise analyzed. One of skill in the art will also appreciate that the length of fixation depends upon the size of the tissue sample and the fixative used. By way of example, neutral buffered formalin, Bouin's or paraformaldehyde, may be used to fix a tissue sample.

Generally, the tissue sample is first fixed and is then dehydrated through an ascending series of alcohols, infiltrated and embedded with paraffin or other sectioning media so that the tissue sample may be sectioned. Alternatively, one may section the tissue and fix the sections obtained. By way of example, the tissue sample may be embedded and processed in paraffin by conventional methodology (See e.g., “Manual of Histological Staining Method of the Armed Forces Institute of Pathology,” 3^{rd} edition (1960) Lee G. Luna, HT (ASCP) Editor). Examples of paraffin that may be used include, but are not limited to, Paraplast, Broloid, and Tissuemay. Once the tissue sample is embedded, the sample may be sectioned by a microtome or the like (See e.g., “Manual of Histological Staining Method of the Armed Forces Institute of Pathology”, supra). By way of example for this procedure, sections may range from about three microns to about five microns in thickness. Once sectioned, the sections may be attached to slides by several standard methods. Examples of slide adhesives include, but are not limited to, silane, gelatin, poly-L-lysine and the like. By way of example, the paraffin embedded sections may be attached to positively charged slides and/or slides coated with poly-L-lysine.

If paraffin has been used as the embedding material, the tissue sections are generally deparaffinized and rehydrated to water. The tissue sections may be deparaffinized by several conventional standard methodologies. For example, xylenes and a gradually descending series of alcohols may be used. Alternatively, commercially available deparaffinizing non-organic agents such as Hemo-De® may be used.

B. Imaging Techniques

According to the present invention, the samples are stained and imaged using well known techniques of microscopy to assess the sample, for example morphological staining, immunochistochemistry and in situ hybridization.

1. Morphological Imaging

After deparaffinization, the sections mounted on slides may be stained with a morphological stain for evaluation. Generally, the section is stained with one or more dyes each of which distinctly stains different cellular components. In a preferred embodiment xanthine dye or the functional equivalent thereof and/or a thiazine dye or the functional equivalent thereof are used to enhance and make distinguishable the nucleus, cytoplasm, and “granular” structures within each. Such dyes are commercially available and often sold as sets. By way of example, HEMA 3® stain set comprises xanthine dye and thiazine dye. Methylene blue may also be used. One of skill in the art will appreciate that staining may be optimized for a given tissue by increasing or decreasing the length of time the slides remain in the dye.

2. Immunohistochemistry

Imnunohistochemical staining of tissue sections has been shown to be a reliable method of assessing alteration of proteins in a heterogeneous tissue. Immunohistochemistry (IHC) techniques utilize an antibody to probe and visualize cellular antigens in situ, generally by chromogenic or fluorescent methods.

Two general methods of IHC are available; direct and indirect assays. According to the first assay, binding of antibody to the target antigen is determined directly. This direct assay uses a labeled reagent, such as a fluorescent tag or an enzyme-labeled primary antibody, which can be visualized without further antibody interaction. In a typical indirect assay, unconjugated primary antibody binds to the antigen and then a labeled secondary antibody binds to the primary antibody. Where the secondary antibody is conjugated to an enzymatic label, a chromogenic or fluorogenic substrate is added to provide visualization of the antigen. Signal amplification occurs because several secondary antibodies may react with different epitopes on the primary antibody.

The primary and/or secondary antibody used for immunohistochemistry typically will be labeled with a detectable moiety. Numerous labels are available which can be generally grouped into the following categories: (a) Radioisotopes, such as ³⁵S, ¹⁴C, ¹²⁵I, ³H, and ¹³¹I. The antibody can be labeled with the radioisotope using the techniques described in Current Protocols in Immunology, Volumes 1 and 2, Coligen et al., Ed. Wiley-Interscience, New York, N.Y., Pubs. (1991) for example and radioactivity can be measured using scintillation counting; (b) Colloidal gold particles; and (c) fluorescent labels as described below, including, but are not limited to, rare earth chelates (europium chelates), Texas Red, rhodamine, fluorescein, dansyl, Lissamine, umbelliferone, phycocrytherin, phycocyanin, or commercially available fluorophores such SPECTRUM ORANGE® and SPECTRUM GREEN® and/or derivatives of any one or more of the above.

Other fluorescent labels contemplated for use include Alexa 350, Alexa 430, Alexa 488, Alexa 555, AMCA, BODIPY 630/650, BODIPY 650/665, BODIPY-FL, BODIPY-R6G, BODIPY-TMR, BODIPY-TRX, Cascade Blue, Cy3, Cy5, 6-FAM, Fluorescein Isothiocyanate, HEX, 6-JOE, Oregon Green 488, Oregon Green 500, Oregon Green 514, Pacific Blue, REG, Rhodamine Green, Rhodamine Red, Renographin, ROX, TAMRA, TET, Tetramethylrhodamine, phycoerythrin, anti-green fluorescent protein (GFP), red fluorescent protein (RFP), nuclear yellow (Hoechst S769121), and 4′,6-diamidino-2-phenylindole, dihydrochloride (DAPI).

Another type of fluroescent compound may include antibody conjugates, which are intended primarily for use in vitro, where the antibody is linked to a secondary binding ligand and/or to an enzyme (an enzyme tag) that will generate a colored product upon contact with a chromogenic substrate that can be measured using various techniques. For example, the enzyme may catalyze a color change in a substrate, which can be measured spectrophotometrically. Alternatively, the enzyme may alter the fluorescence or chemiluminescence of the substrate. The chemiluminescent substrate becomes electronically excited by a chemical reaction and may then emit light which can be measured (using a chemiluminometer, for example) or donates energy to a fluorescent acceptor. Examples of enzymatic labels include luciferases (e.g., firefly luciferase and bacterial luciferase; U.S. Pat. No. 4,737,456), luciferin, 2,3-dihydrophthalazinediones, malate dehydrogenase, urease, peroxidase such as horseradish peroxidase (HRPO), alkaline phosphatase, beta.-galactosidase, glucoamylase, lysozyme, saccharide oxidases (e.g., glucose oxidase, galactose oxidase, and glucose-6-phosphate dehydrogenase), heterocyclic oxidases (such as uricase and xanthine oxidase), lactoperoxidase, microperoxidase, and the like.

Specifically, examples of enzyme-substrate combinations include, for example: (i) Horseradish peroxidase (HRPO) with hydrogen peroxidase as a substrate, wherein the hydrogen peroxidase oxidizes a dye precursor [e.g.,orthophenylene diamine (OPD) or 3,3′,5,5′-tetramethyl benzidine hydrochloride (TMB)]; (ii) alkaline phosphatase (AP) with para-Nitrophenyl phosphate as chromogenic substrate; and (iii) β-D-galactosidase (β-D-Gal) with a chromogenic substrate (e.g., p-nitrophenyl-β-D-galactosidase) or fluorogenic substrate (e.g., 4-methylumbelliferyl-β-D-galactosidase). Numerous other enzyme-substrate combinations are available to those skilled in the art. For a general review of these, see U.S. Pat. Nos. 3,817,837; 3,850,752; 3,939,350; 3,996,345; 4,277,437; 4,275,149 and 4,366,241, which are incorporated herein by reference.

Techniques for conjugating enzymes to antibodies are described in O'Sullivan et al., Methods for the Preparation of Enzyme-Antibody Conjugates for use in Enzyme Immunoassay, in Methods in Enzyme. (ed J. Langone & H. Van Vunakis), Academic press, New York, 73:147-166 (1981). Several methods are known in the art for the attachment or conjugation of an antibody to its conjugate moiety. Some attachment methods involve the use of a metal chelate complex employing, for example, an organic chelating agent such a diethylenetriaminepentaacetic acid anhydride (DTPA); ethylenetriaminetetraacetic acid; N-chloro-p-toluenesulfonamide; and/or tetrachloro-3α-6α-diphenylglycouril-3 attached to the antibody (U.S. Pat. Nos. 4,472,509 and 4,938,948, each incorporated herein by reference). Monoclonal antibodies may also be reacted with an enzyme in the presence of a coupling agent such as glutaraldehyde or periodate. Conjugates with fluorescein markers are prepared in the presence of these coupling agents or by reaction with an isothiocyanate. In U.S. Pat. No. 4,938,948, imaging of breast tumors is achieved using monoclonal antibodies and the detectable imaging moieties are bound to the antibody using linkers such as methyl-p-hydroxybenzimidate or N-succinimidyl-3-(4-hydroxyphenyl) propionate.

Sometimes, the label is indirectly conjugated with the antibody. The skilled artisan will be aware of various techniques for achieving this. For example, the antibody can be conjugated with biotin and any of the four broad categories of labels mentioned above can be conjugated with avidin, or vice versa. Biotin binds selectively to avidin and thus, the label can be conjugated with the antibody in this indirect manner. Alternatively, to achieve indirect conjugation of the label with the antibody, the antibody is conjugated with a small hapten and one of the different types of labels mentioned above is conjugated with an anti-hapten antibody. Thus, indirect conjugation of the label with the antibody can be achieved.

Aside from the sample preparation procedures discussed above, further treatment of the tissue section prior to, during or following IHC may be desired, For example, epitope retrieval methods, such as heating the tissue sample in citrate buffer may be carried out (Leong et al., 1996).

Following an optional blocking step, the tissue section is exposed to primary antibody for a sufficient period of time and under suitable conditions such that the primary antibody binds to the target protein antigen in the tissue sample. Appropriate conditions for achieving this can be determined by routine experimentation.

The extent of binding of antibody to the sample is determined by using any one of the detectable labels discussed above. Preferably, the label is an enzymatic label (e.g. HRPO) which catalyzes a chemical alteration of the chromogenic substrate such as 3,3′-diaminobenzidine chromogen. Preferably the enzymatic label is conjugated to antibody which binds specifically to the primary antibody (e.g. the primary antibody is rabbit polyclonal antibody and secondary antibody is goat anti-rabbit antibody).

Specimens thus prepared may be mounted and coverslipped. Slide evaluation is then determined, e.g. using a microscope and imaged using standard techniques to form a dataset to be used in the segmentation method of the present invention.

3. Fluorescence In Situ Hybridization

Fluorescence in situ hybridization (FISH) is a recently developed method for directly assessing the presence of genes in intact cells. In situ hybridization is generally carried out on cells or tissue sections fixed to slides. In situ hybridization may be performed by several conventional methodologies ([See for e.g. Leitch et al., 1994). In one in situ procedure, fluorescent dyes [such as fluorescein isothiocyanate (FITC) which fluoresces green when excited by an Argon ion laser] are used to label a nucleic acid sequence probe which is complementary to a target nucleotide sequence in the cell. Each cell containing the target nucleotide sequence will bind the labeled probe producing a fluorescent signal upon exposure, of the cells to a light source of a wavelength appropriate for excitation of the specific fluorochrome used.

Various degrees of hybridization stringency can be employed. As the hybridization conditions become more stringent, a greater degree of complementarity is required between the probe and target to form and maintain a stable duplex. Stringency is increased by raising temperature, lowering salt concentration, or raising formamide concentration. Adding dextran sulfate or raising its concentration may also increase the effective concentration of labeled probe to increase the rate of hybridization and ultimate signal intensity. After hybridization, slides are washed in a solution generally containing reagents similar to those found in the hybridization solution with washing time varying from minutes to hours depending on required stringency. Longer or more stringent washes typically lower nonspecific background but run the risk of decreasing overall sensitivity.

Probes used in the FISH analysis may be either RNA or DNA oligonucleotides or polynucleotides and may contain not only naturally occurring nucleotides but their analogs like digoxygenin dCTP, biotin dcTP 7-azaguanosine, azidothymidine, inosine, or uridine. Other useful probes include peptide probes and analogues thereof, branched gene DNA, peptidometics, peptide nucleic acid (PNA) and/or antibodies.

Probes should have sufficient complementarity to the target nucleic acid sequence of interest so that stable and specific binding occurs between the target nucleic acid sequence and the probe. The degree of homology required for stable hybridization varies with the stringency of the hybridization medium and/or wash medium. Preferably, completely homologous probes are employed in the present invention, but persons of skill in the art will readily appreciate that probes exhibiting lesser but sufficient homology can be used in the present invention [see for e.g. Sambrook, J., Fritsch, E. F., Maniatis, T., Molecular Cloning A Laboratory Manual, Cold Spring Harbor Press, (1989)].

One of skill in the art will appreciate that the choice of probe will depend on the genetic abnormality of interest. Genetic abnormalities that can be detected by this method include, but are not limited to, amplification, translocation, deletion, addition and the like.

Probes may also be generated and chosen by several means including, but not limited to, mapping by in situ hybridization, somatic cell hybrid panels, or spot blots of sorted chromosomes; chromosomal linkage analysis; or cloned and isolated from sorted chromosome libraries from human cell lines or somatic cell hybrids with human chromosomes, radiation somatic cell hybrids, microdissection of a chromosome region, or from yeast artificial chromosomes (YACs) identified by PCR primers specific for a unique chromosome locus or other suitable means like an adjacent YAC clone. Probes may be genomic DNA, cDNA, or RNA cloned in a plasmid, phage, cosmid, YAC, Bacterial Artificial Chromosomes (BACs), viral vector, or any other suitable vector. Probes may be cloned or synthesized chemically by conventional methods. When cloned, the isolated probe nucleic acid fragments are typically inserted into a vector, such as lambda phage, pBR322, M13, or vectors containing the SP6 or T7 promoter and cloned as a library in a bacterial host. [See for e.g. Sambrook, J., Fritsch, E. F., Maniatis, T., Molecular Cloning A Laboratory Manual, Cold Spring Harbor Press, (1989)].

Probes are preferably labeled with a fluorophor. Examples of fluorophores include, but are not limited to, rare earth chelates (europium chelates), Texas Red, rhodamine, fluorescein, dansyl, Lissamine, umbelliferone, phycocrytherin, phycocyanin, or commercially available fluorophors such SPECTRUM ORANGE® and SPECTRUM GREEN® and/or derivatives of any one or more of the above. Multiple probes used in the assay may be labeled with more than one distinguishable fluorescent or pigment color. These color differences provide a means to identify the hybridization positions of specific probes. Moreover, probes that are not separated spatially can be identified by a different color light or pigment resulting from mixing two other colors (e.g., light red+green=yellow) pigment (e.g., green+blue=cyan) or by using a filter set that passes only one color at a time.

Probes can be labeled directly or indirectly with the fluorophor, utilizing conventional methodology. Additional probes and colors may be added to refine and extend this general procedure to include more genetic abnormalities or serve as internal controls.

After processing for FISH, the slides may be analyzed by standard techniques of fluorescence microscopy [see for e.g. Ploem and Tanke Introduction to Fluorescence Microscopy, New York, Oxford University Press (1987)] to form a dataset to be used in the segmentation method of the present invention.

Briefly, each slide is observed using a microscope equipped with appropriate excitation filters, dichromic, and barnier filters. Filters are chosen based on the excitation and emission spectra of the fluorochromes used. Photographs of the slides may be taken with the length of time of film exposure depending on the fluorescent label used, the signal intensity and the filter chosen. For FISH analysis the physical loci of the cells of interest determined in the morphological analysis are recalled and visually conformed as being the appropriate area for FISH quantification.

C. Hyperproliferative Disease Diagnostic

In accordance with the present invention, samples are obtained from a subject suspected of having or being at risk for a hyperproliferative disease. The samples are isolated according to the above methods, stained with a label, such as a fluorescent label, and imaged to obtain an image dataset that is analyzed using the segmentation method of the present invention.

Segmentation allows the user to determine if the sample contains or is at risk for containing hyperproliferative cells. Segmentation provides counts of abnormal and/or normal cells. The counts of abnormal cells may include the counting of the actual abnormal cell, counting labeled telomeres in cells, counting cells containing translocation, etc.

The hyperproliferative disease includes, but is not limited to neoplasms. A neoplasm is an abnormal tissue growth, generally forming a distinct mass that grows by cellular proliferation more rapidly than normal tissue growth. Neoplasms show partial or total lack of structural organization and functional coordination with normal tissue. These can be broadly classified into three major types. Malignant neoplasms arising from epithelial structures are called carcinomas, malignant neoplasms that originate from connective tissues such as muscle, cartilage, fat or bone are called sarcomas and malignant tumors affecting hematopoietic structures (structures pertaining to the formation of blood cells) including components of the immune system, are called leukemias, lymphomas and myelomas. A tumor is the neoplastic growth of the disease cancer. As used herein, a “neoplasm”, also referred to as a “tumor”, is intended to encompass hematopoietic neoplasms as well as solid neoplasms. Examples of neoplasms include, but are not limited to melanoma, non-small cell lung, small-cell lung, lung, hepatocarcinoma, retinoblastoma, astrocytoma, gliobastoma, gum, tongue, leukemia, neuroblastoma, head, neck, breast, pancreatic, prostate, bladder, renal, bone, testicular, ovarian, mesothelioma, sarcoma, cervical, gastrointestinal, lymphoma, brain, colon, bladder, myeloma, or other malignant or benign neoplasms.

Still further, the tumor and/or neoplasm is comprised of tumor cells. For example, tumor cells may include, but are not limited to melanoma cell, a bladder cancer cell, a breast cancer cell, a lung cancer cell, a colon cancer cell, a prostate cancer cell, a bladder cancer cell, a liver cancer cell, a pancreatic cancer cell, a stomach cancer cell, a testicular cancer cell, a brain cancer cell, an ovarian cancer cell, a lymphatic cancer cell, a skin cancer cell, a brain cancer cell, a bone cancer cell, or a soft tissue cancer cell.

Other hyperproliferative diseases include, but are not limited to neurofibromatosis, rheumatoid arthritis, Waginer's granulomatosis, Kawasaki's disease, lupus erathematosis, midline granuloma, inflammatory bowel disease, osteoarthritis, leiomyomas, adenomas, lipomas, hemangiomas, fibromas, vascular occlusion, restenosis, atherosclerosis, pre-neoplastic lesions, carcinoma in situ, oral hairy leukoplakia, or psoriasis, and pre-leukemias, anemia with excess blasts, and myelodysplastic syndrome.

D. Other Uses of Segmentation

The present invention provides a novel method for using the segmentation method of the present invention to identify segmented objects. It is contemplated that the segmentation method of the present invention can be used in a variety of biological applications and/or other applications in which objects within 2- or 3-dimensional space need to be identified from any type of digital image. Thus, segmentation provides a rapid and automated quantitation of image features, for example, but not limited to counts of viral particles, bacterial particles, fungal particles, other microbial particles, counts of abnormal and/or normal cells, determination and/or quantification of the expression level of a gene of interest, and/or determination and/or quantification of the expression level of a protein of interest, information relating to cell structures (e.g., number of synapses per neuron, where each synapse is marked, senile plaques, other inclusions, etc.

It is envisioned that the segmentation method of the present invention can be used to correlate chromatin unwinding with gene expression. For example, the nucleus of the cell is labeled in addition to transcription binding factors. The samples are imaged and segmented, which allows for the analysis of transcriptional activity. Transcriptional activity is correlated to the intensity of the segmented object as an indicator of the activity of a promoter (DNA-protein interaction). Determination of gene expression may be used to diagnosis a disease state or condition in a subject. Still further, the absence of gene expression may also be used to diagnosis a disease state or condition in a subject. Yet further, the present invention may be used as a general laboratory technique to measure the presence and/or absence and/or levels of a gene of interest.

In further embodiments, segmentation can be used to determine cell growth and/or proliferation. Telomeres and their components are involved in many essential processes: control of cell division number, regulation of transcription, reparation. Thus, using the segmentation methods of the present invention, telomeres can be measured as an indicator of cell growth. The intensity of the telomeres or the amount of cells containing an increased intensity of telomeres indicates cells that are undergoing growth and/or proliferation.

Still further, segmentation can be used to determine the amount of viral particles or bacterial particles. For example, a blood sample or any other biological sample can be obtained from a subject and is analyzed to determine the viral load for the subject. The determination of a viral load or bacterial load for a subject can be used to diagnose and/or stage the disease or condition of a subject at risk or having human immunodeficiency virus (HIV), herpes simplex virus (HSV) hepatitis C virus (HCV), influenza virus and respiratory syncytial virus (RSV), sepsis or any other bacterial infection.

Another aspect of the present invention includes a method of determining and/or quantifying the expression level of a gene of interest comprising the steps of: obtaining a biological sample; contacting said sample with a substance that can be used to determine the expression level of a gene of interest (e.g., nuclei acid probe, etc.); imaging the sample to obtain an image dataset; and using the aforementioned method to identify one or more segmented objects such that the identified segmented objects correlate with the gene expression level.

Still further, another aspect includes a method of determining and/or quantifying the expression level of a protein of interest comprising the steps of: obtaining a biological sample; contacting said sample with a substance that can be used to determine the expression level of a protein of interest (e.g., enzyme-tagged antibody or peptide or other substances); imaging the sample to obtain an image dataset; and using the aforementioned method to identify one or more segmented objects such that the identified segmented objects correlate with the protein expression level.

Another aspect of the present invention includes a method of identifying cell structures comprising the steps of: obtaining a biological sample; contacting said sample with a substance that can be used to identify a cell structure of interest (e.g., synapses per neuron, where each synapse is marked, mitochondria, nuclei, golgi apparati, flagella, endoplasmic reticulum, centroles, lysosomes, peroxisomes, chloroplasts, vacuoles, viral capsids, etc.); imaging the sample to obtain an image dataset; and using the aforementioned method to identify one or more segmented objects such that the identified segmented objects correlate with the cell structure.

Still further, another aspect of the present invention includes a method of identify neurodegenerative diseases postmortem comprising the steps of: obtaining a biological sample; contacting said sample with a substance that can be used to identify senile plaques and/or other inclusions that are associated with neurodegenerative diseases (i.e., Alzheimer's disease, amyotrophic lateral sclerosis (ALS), Parkinson's disease, and/or Huntington's Disease); imaging the sample to obtain an image dataset; and using the aforementioned method to identify one or more segmented objects such that the identified segmented objects correlate with the senile plaques and/or other inclusions and are used as an indication of neurodegenerative disease. Still further, the present invention can also be used to quantify the number of senile plaques and/or inclusions in a postmortem sample.

### IV. EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

Drosophila Brain Nuclei Segmentation

In one example, the computer-implemented method was tested on 3-dimensional images of the Drosophila brain nuclei.

An objective of the test was to replace the large and complex images of the Drosophila brain nuclei with simple representations of the brain nuclei in space. To do so, the optical center of mass was defined as the centroid for each nucleus. This provided for a simple and intuitive way to assign a point in space to that object. Another objective was to define the object (the nucleus in this case) as a set of image voxels that approximates the visible nucleus (that is, a nucleus as it appears to a trained researcher) in size, shape, and volume.

There are two apparent facts about the nuclei: they are on average brighter than the background and are generally round in shape. However, there were fluorescence intensity fluctuations both in the background and within the nuclei. To complicate the problem, some extraneous material that existed in every preparation (trachea) that fluoresced above background needed to be identified as non-nuclear.

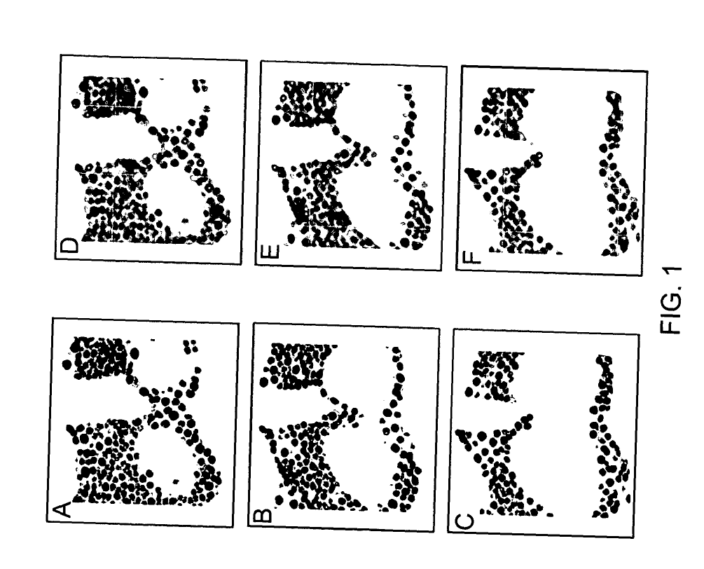

The brain nuclei were labeled with a fluorescent compound and imaged. FIGS. 1(A-F) illustrate several Z-sections of a typical Z-stack of the brain nuclei. Each Z-stack typically represented a volume of 158.7×158.7×100 microns and each voxel represented a volume of 0.31×0.31×0.3 microns. Shown were three sections from a typical image of a Drosophila brain at various depths. FIG. 1(a) at 12 μm deep, (b) at 17 μm deep and (c) at 23 μm deep. In FIGS. 1(d-f), the result of smoothing and segmentation were shown for the same three Z-sections as in FIGS. 1(a-c), respectively. The centroids of nuclei were shown as squire marks (3×3×1 voxels, the center of the marks was the actual centroid). Since only isolated slices from the same Z-stack were shown, not all nuclei were marked: more centroids were located in other planes. The overlayed grid aided in visual reference to the centroids.

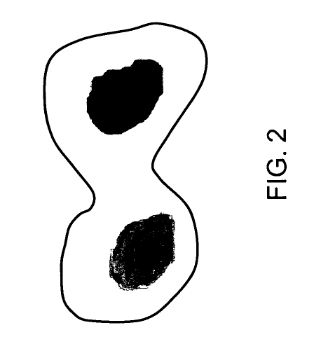

FIG. 2 illustrated a situation when two nearby nuclei were segmented by allowing for sufficiently high and different threshold values. A possible situation with difficult to segment nuclei was shown: the two nuclei appeared to be fused because of their proximity. FIG. 2 is a two-dimensional illustration of the 2-dimensional segmentation technique. The grey voxels were discarded as non-valid. The smaller islands corresponded to valid defining sets with their own thresholds (or the intensities of their dimmest voxels, t1≠t2) leading to properly defined centroids.

The properties of the initial defining set were determined by covariances of the data points (i.e., voxels) within the set. If the same image could be recorded many times without bleaching (a hypothetical situation), the noise in it would lead to a number of slightly different initial defining sets for a given nuclei. Because all of them had to satisfy the restricting conditions, they all should overlap, thus maximizing the likelihood for the majority of data points in a particular realization of an initial defining set to belong to its corresponding nuclei.

The results of the test segmentation with Drosophila brain images showed that the method was extremely accurate and provided detailed information about the locations of neurons in the Drosophila brain. Centroids of each object (nucleus of each neuron) were also recorded into an algebraic matrix that described the locations of the neurons.

The optical center of each segmented nucleus, or the centroid, was displayed as a colored mark superimposed on the nucleus. Many of the nuclei shown in FIG. 1 remain unmarked because their centroid occurred on a nearby Z-slice of the stack. This graphical marking facilitated subsequent visual inspection of the stack in order to determine the precision of segmentation. The XYZ locations of all centroids in space may be listed in tabular output relative to the lower left comer of the first Z-slice. In the figure, the coordinates represented micron distances (typically, a unit distance in the matrix corresponds to 0.3 μm). The point-list matrix of the brain (the x,y,z coordinates of the nuclei) can be visualized with a GUI.

### Example 2

Measurement of Gene Expression

Gene expression was measured using the segmentation method described in the Example 1. HeLa cells were labeled with fluorescent compounds and imaged. Green fluorescent protein (GFP) was used to mark the cellular position of a transcription factor (protein fusion) binding to DNA. Red fluorescent protein (RFP) gene was the cellular target of the transcription factor and was used to follow the cellular position of the protein product of the gene activated by the transcription factor. Finally, 4′,6-diamidino-2-phenylindole, dihydrochloride (DAPI) was used to label the nucleus.

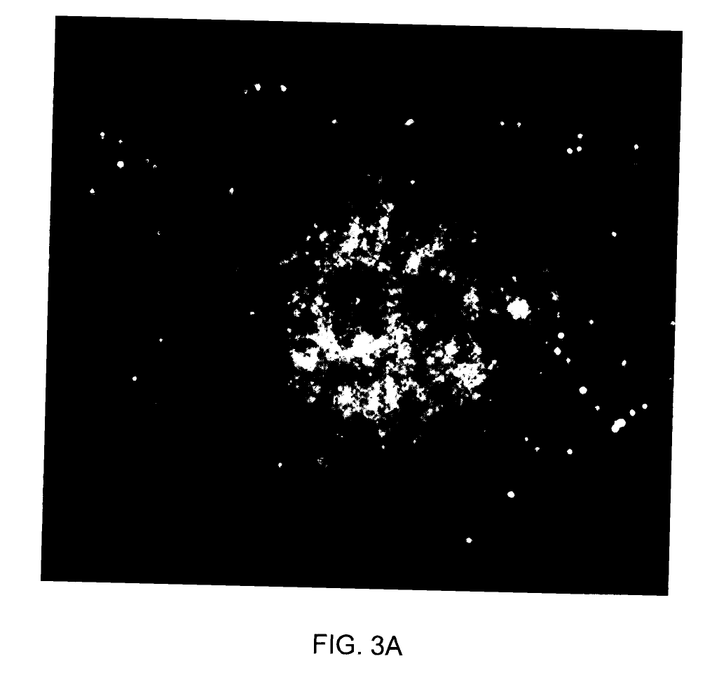

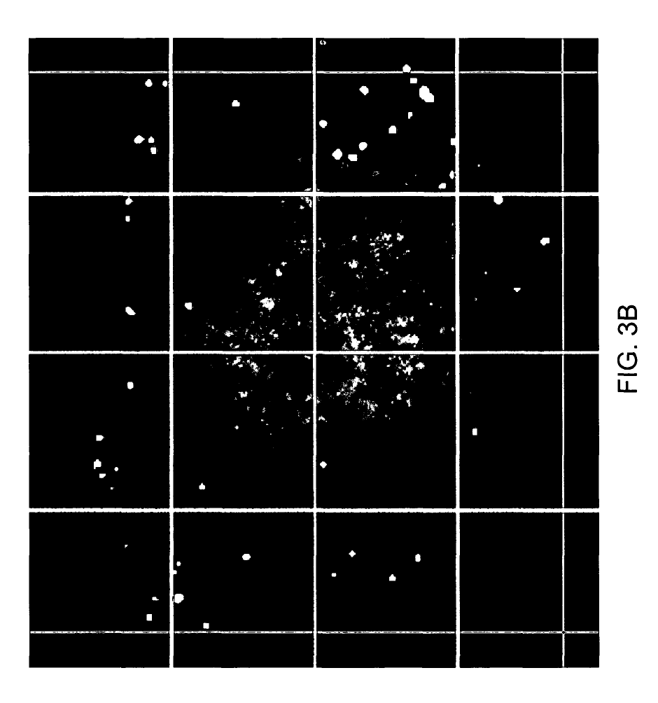

FIG. 3A and FIG. 3B show a HeLa cell that was segmented based upon the binding of GFP to specific DNA sequences. The nucleus was the large blue object and the color sets were protein aggregates that indicated activity of a promoter. The 3-dimensional segmentation in the red color channel identified the intensity of light and the volume of these objects. The intensity of the segmented objects was an indicator of the activity of a promoter (DNA-protein interaction) which correlated to transcriptional activity or gene expression.

### Example 3

Diagnosis of Prostate Cancer

A biological sample (tissue biopsy) was obtained from a subject suspected of having prostate cancer. The sample was stained using an enzyme substrate combination, such as horseradish peroxidase with hydrogen peroxidase to form a brown chromogen.

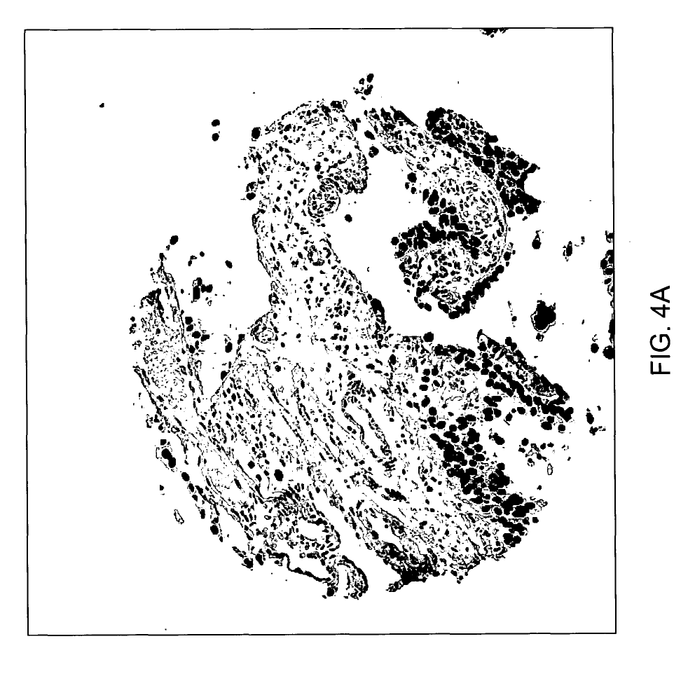

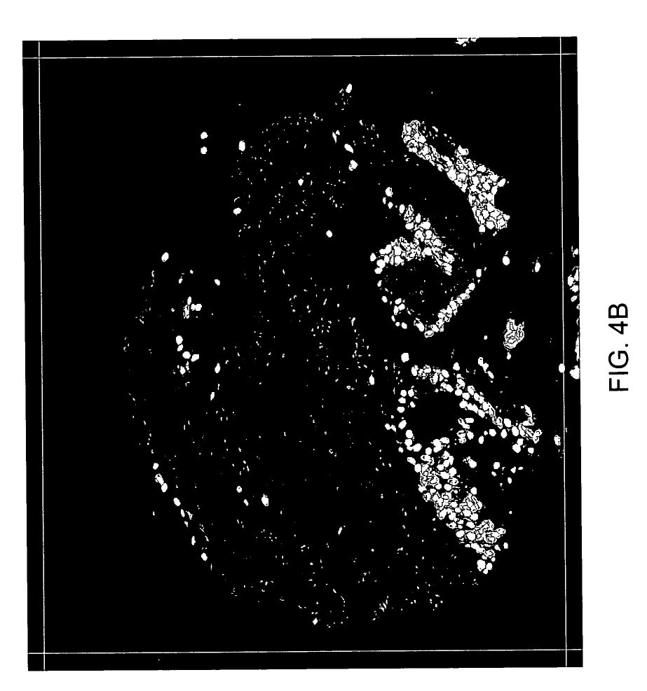

FIG. 4A shows the cancer cells that are shown as the brown chromogen. FIG. 4B shows the segmentation into objects and the precise count of cells that were labeled to determine or use as a measure of malignancy.

### Example 4

Diagnosis of Bladder Cancer

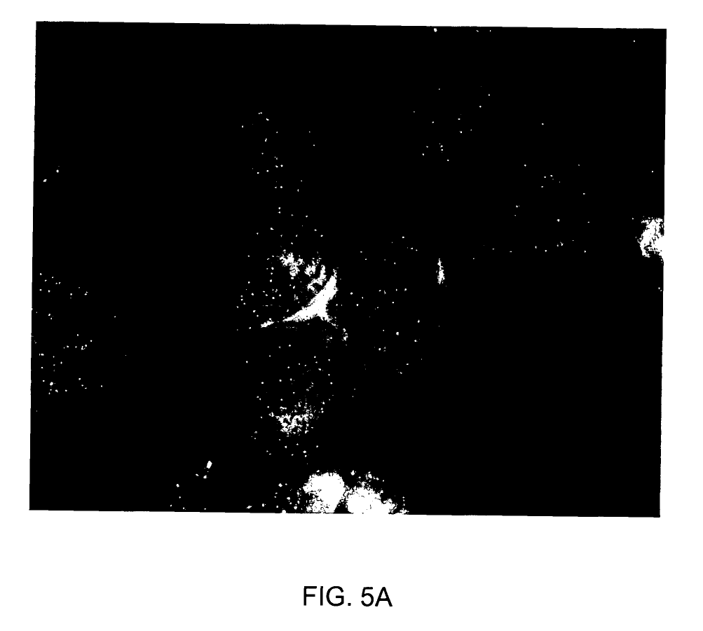

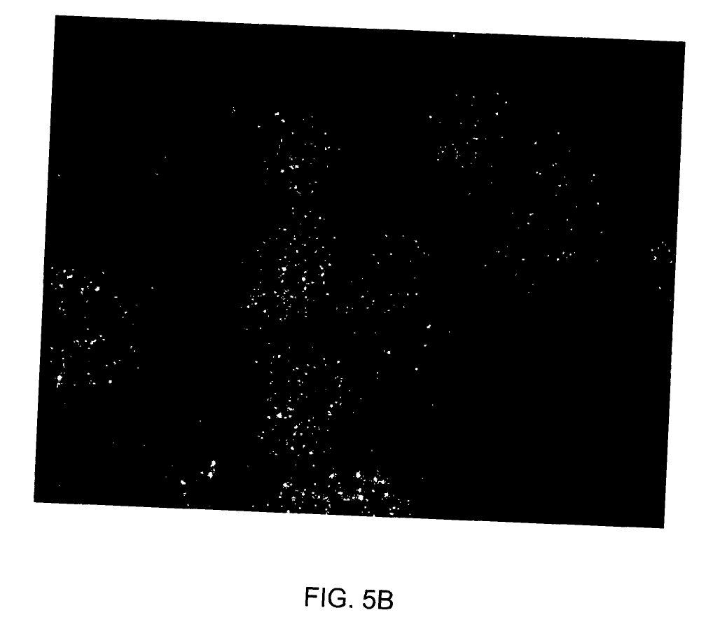

A biological sample (needle aspiration) was obtained from a subject suspected of having bladder cancer. The telomeres of the cells were labeled in green as detected by fluorescence in situ hybridization. Each dot corresponds to one telomere and the average telomere length corresponds to the intensity of the green dot on an image. FIG. 5A shows the telomeres that were labeled in green. FIG. 5B shows the segmentation of telomeres into objects. The objects were counted and the area that they cover was calculated and evaluated to determine the intensity of the marker as a measure of malignancy.

### Example 5

Diagnosis of Lymphoma

A biological sample was obtained from a subject suspected of having non-Hodgkin's lymphoma. The sample was stained using fluorescent compounds and imaged. The nuclei were stained using 4′,6-diamidino-2-phenylindole, dihydrochloride (DAPI).

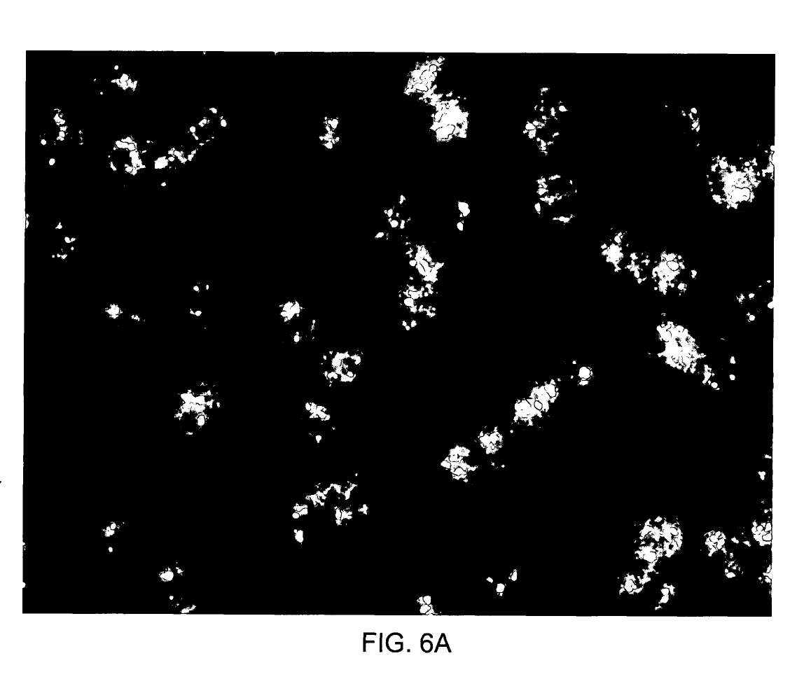

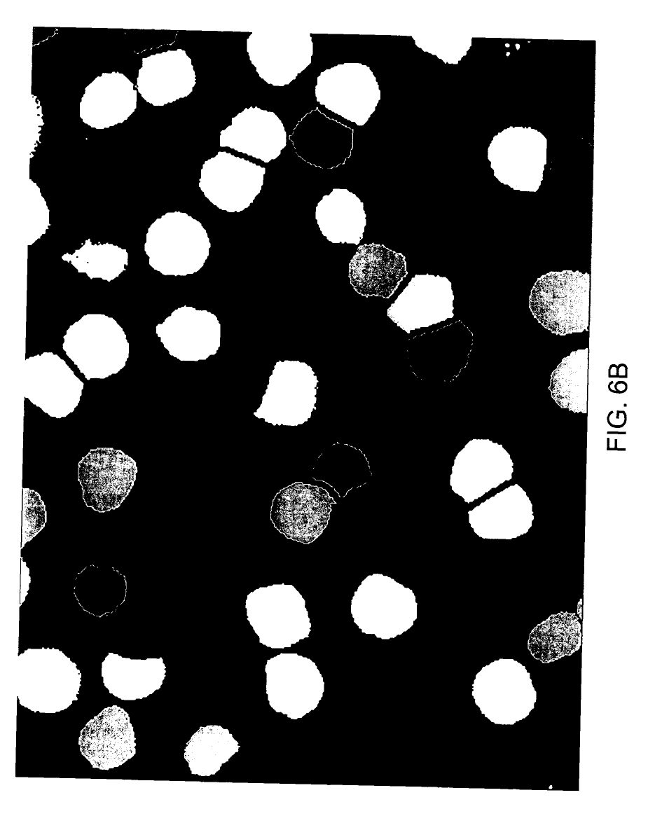

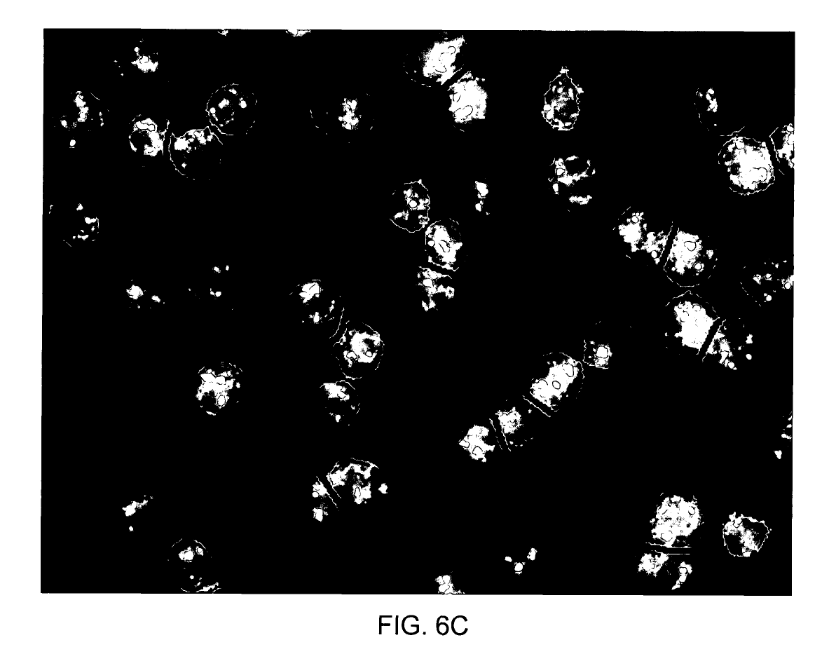

Fluorescence in situ hybridization (FISH) was used to label the gene for cyclin D1 (red) and IgH (green). FISH is used for localizing and determining the relative abundance of specific nucleic acid sequences in cells, tissue, interphase nuclei and metaphase chromosomes. FIG. 6A shows that the nuclei were stained blue and the cyclin D1 genes (11q13) were stained red and the IgH genes (14q32) were stained green. When the two genes ended up in proximity because of a chromosomal translocation, a yellow spot indicating the overlap of green and red is observed.

FIG. 6B shows the results after the first round of two-dimensional segmentation. FIG. 6C shows that the yellow spots or spots of translocation were segmented. These cells containing translocation were counted as an indication of lymphoma.

References

All patents and publications mentioned in the specifications are indicative of the levels of those skilled in the art to which the invention pertains. All patents and publications are herein incorporated by reference to the same extent as if each individual publication was specifically and individually indicated to be incorporated by reference.

Chen, K., Wang, D. (2002) A Dynamically Coupled Neural Oscillator Network for Image Segmentation. Neural Networks, 15, 423-39

Mardia, K. V., Hainsworth, T. J. (1988) A Spatial Thresholding Method for Image Segmentation, IEEE Transactions on Pattern Analysis and Machine Intelligence, vol. 10, no. 6, 919-27

Oh, W., Lindquist, W. B. (1999) Image Thresholding by Indicator Kriging, IEEE Transactions on Pattern Analysis and Machine Intelligence, 21(7), 590-602

Shareef, N., Wang, D. L., Yagel, R. (1997) Segmentation of Medical Images Using LEGION. Technical Report: OSU-CISRC-4/97-TR26, Ohio State University.

Leong et al. Appl. Immunohistochem. 4(3):201 (1996).

Leitch et al. In Situ Hybridization: a practical guide, Oxford BIOS Scientific Publishers, Micropscopy handbooks v. 27 (1994)

Xifeng Wu et al. Telomere Dysfunction: A Potential Cancer Predisposition Factor, Journal of the National Cancer Institute, vol. 95, no. 16 (2003)

Various embodiments of the present invention have been described herein. It should be understood by those of ordinary skill in the art, however, that the above described embodiments of the present invention are set forth merely by way of example and should not be interpreted as limiting the scope of the present invention, which is defined by the appended claims. Many other alternative embodiments, variations and modifications of the foregoing embodiments that embrace various aspects of the present invention will also be understood upon a reading of the detailed description in light of the prior art. For instance, it will be understood that features of one embodiment may be combined with features of other embodiments while many other features may be omitted (or replaced) as being nonessential to the practice of the present invention.

What is claimed is:

1. A computer-implemented method for segmenting objects, the method comprising the steps:
reading an image dataset containing an electronic representation of an image, said image having a plurality of data points;
determining one or more initial defining sets by finding interconnected sets of said data points;
determining one or more valid defining sets by applying one or more restricting conditions to said initial defining sets; and
identifying one or more segmented objects.

2. The computer-implemented method of claim 1, wherein said data points have an associated intensity value.

3. The computer-implemented method of claim 1, wherein said data points have an associated Red, Green, Blue value.

4. The computer-implemented method of claim 1, wherein said data points are pixels.

5. The computer-implemented method of claim 1, wherein said data points are voxels.

6. The computer-implemented method of claim 1, wherein finding interconnected sets of said data points includes finding a path of successive neighboring data points where a subsequent neighboring data point has an intensity value equal to or greater than an intensity value of a previous data point; and
wherein said path is limited to a predetermined length of data points.

7. The computer-implemented method of claim 1, wherein the path is linear.

8. The computer-implemented method of claim 7, wherein the path is also diagonal.

9. The computer-implemented method of claim 1, wherein said electronic representation of an image is a 2-dimensional representation.

10. The computer-implemented method of claim 1, wherein said electronic representation of an image is a 3-dimensional representation.

11. The computer-implemented method of claim 1, wherein said electronic representation of an image is a grey-scale or color representation.

12. The computer-implemented method of claim 1, wherein said image dataset is in JPEG, BMP, TIFF or GIF format.

13. The computer-implemented method of claim 1, wherein said image dataset is a database, a computer file, or an array of data in computer memory.

14. The computer-implemented method of claim 1, wherein applying one or more restricting conditions includes applying a criteria for an initial defining set, such that said initial defining set will be excluded from being a valid defining set.

15. The computer-implemented method of claim 1, wherein applying one or more restricting conditions includes applying a criteria for an initial defining set, such that said initial defining set will be included as being a valid defining set.

16. The computer-implemented method of claim 1, wherein applying one or more restricting conditions includes excluding said initial defining set where the initial defining set has a volume greater than or equal to a predetermined maximum volume.

17. The computer-implemented method of claim 1, wherein applying one or more restricting conditions includes excluding said initial defining set where the initial defining set has a volume lesser than or equal to a predetermined minimum volume.

18. The computer-implemented method of claim 1, wherein applying one or more restricting conditions includes excluding an initial defining set where the initial defining set has an extent in an x- and y-direction greater than a predetermined maximum extent.

19. The computer-implemented method of claim 1, wherein applying one or more restricting conditions includes excluding an initial defining set where the initial defining set has an extent in a z-direction greater than a predetermined maximum extent.

20. The computer-implemented method of claim 1, wherein applying one or more restricting conditions includes excluding said initial defining set where the initial defining set has a sphericity greater than or equal to a predetermined maximum sphericity.

21. The computer-implemented method of claim 1, wherein applying one or more restricting conditions includes excluding said initial defining set where the initial defining set has a sphericity lesser than or equal to a predetermined minimum sphericity.

22. The computer-implemented method of claim 1, further comprising counting said segmented objects.

23. The computer-implemented method of claim 1, further comprising displaying said segmented objects in a graphical user interface.

24. The computer-implemented method of claim 1, further comprising determining a centroid for said segmented objects.

25. The computer-implemented method of claim 24, further comprising displaying said centroids for said segmented objects.

26. The computer-implemented method of claim 25, further comprising overlaying a grid with said centroids to aid in visual reference of said centroids.

27. The computer-implemented method of claim 1, further comprising determining an intensity threshold for said segmented objects.

28. The computer-implemented method of claim 27, wherein the intensity threshold for a particular segmented object is the intensity of the dimmest voxel, where said image is a 3-dimensional image.

29. The computer-implemented method of claim 27, wherein the intensity threshold for a particular segmented object is the intensity of the dimmest pixel, where said image is a 2-dimensional image.

30. The computer-implemented method of claim 1, further comprising smoothing said image to remove image artifacts from said image before the step of determining one or more initial defining sets.

31. A method of determining transcriptional activity of a gene of interest comprising the steps of:
obtaining a biological sample;
imaging the sample to obtain an image dataset; and
using the computer-implemented method of claim 1 to identify one or more segmented objects, wherein the identified segmented objects correlate to the transcriptional activity.

32. A method of diagnosing a hyperproliferative disease comprising the steps of:
obtaining a biological sample from a subject;
imaging the sample to obtain an image dataset; and
using the computer-implemented method of claim 1 to identify one or more segmented objects, wherein the identified segmented objects correlate to the hyperproliferative disease.

33. The method of claim 32, wherein the hyperproliferative disease is further defined as cancer.

34. The method of claim 34, wherein the cancer comprises a neoplasm.

35. The method of claim 34, wherein the neoplasm is selected from the group consisting of melanoma, non-small cell lung, small-cell lung, lung hepatocarcinoma, retinoblastoma, astrocytoma, gliobastoma, leukemia, neuroblastoma, squamous cell, head, neck, gum, tongue, breast, pancreatic, prostate, renal, bone, testicular, ovarian, mesothelioma, sarcoma, cervical, gastrointestinal, lymphoma, brain, colon, and bladder.

36. The method of claim 35, wherein the neoplasm is prostate cancer.

37. A method of screening a subject at risk for developing a hyperproliferative disease comprising the steps of:
obtaining a biological sample from a subject;
imaging the sample to obtain an image dataset; and
using the computer-implemented method of claim 1 to identify one or more segmented objects, wherein the identified segmented objects correlate to the hyperproliferative disease.

38. A method of staging or monitoring a hyperproliferative disease in a subject comprising the steps of:
obtaining a biological sample from a subject;
imaging the sample to obtain an image dataset; and
using the computer-implemented method of claim 1 to identify one or more segmented objects, wherein the identified segmented objects correlate to the hyperproliferative disease.

39. A method of determining the expression level of a gene of interest comprising the steps of:
obtaining a biological sample;
imaging the sample to obtain an image dataset; and
using the computer-implemented method of claim 1 to identify one or more segmented objects, wherein the identified segmented objects correlate to the expression level of the gene.

40. A method of determining the expression level of a protein of interest comprising the steps of:
obtaining a biological sample;
imaging the sample to obtain an image dataset; and
using the computer-implemented method of claim 1 to identify one or more segmented objects, wherein the identified segmented objects correlate to the expression level of the protein.

41. A method of determining a cell structure of interest comprising the steps of:
obtaining a biological sample;
imaging the sample to obtain an image dataset; and
using the computer-implemented method of claim 1 to identify one or more segmented objects, wherein the identified segmented objects correlate to the cell structure.
